(19) United States
(12) Patent Application Publication
(10) Pub. No.: US 2023/0088699 A1
(43) Pub. Date: Mar. 23, 2023

(54) REINFORCEMENT LEARNING APPARATUS AND METHOD BASED ON USER LEARNING ENVIRONMENT

(71) Applicant: AGILESODA INC., Seoul (KR)

(72) Inventors: Ye Rin MIN, Namyangju-si (KR); Yeon Sang YU, Gwangju (KR); Sung Min LEE, Seongnam-si (KR); Won Young CHO, Yeosu-si (KR); Ba Da KIM, Seoul (KR); Dong Hyun LEE, Seongnam-si (KR)

(73) Assignee: AGILESODA INC., Seoul (KR)

(21) Appl. No.: 17/878,482

(22) Filed: Aug. 1, 2022

(30) Foreign Application Priority Data
Sep. 17, 2021 (KR) 10-2021-0124865

(51) Int. Cl. G06K 9/62; G06F 30/27

(52) U.S. Cl. CPC G06K 9/6262; G06F 30/27

(57) ABSTRACT

Disclosed is a user learning environment-based reinforcement learning apparatus and method. According to the disclosure, a CAD data based-reinforcement learning environment may be easily set by a user using a user interface (UI) and a drag and drop, a reinforcement learning environment may be promptly configured, and reinforcement learning may be performed based on the learning environment set by the user, and thus the optimized location of a target object may be automatically produced in various environments.

### CROSS-REFERENCE TO RELATED APPLICATION(S)

This application is based on and claims priority under 35 U.S.C. 119 to Korean Patent Application No. 10-2021-0124865, filed on Sep. 17, 2021, in the Korean Intellectual Property Office, the disclosure of which is herein incorporated by reference in its entirety.

### BACKGROUND

### 1. Field

The present disclosure relates to a user learning environment-based reinforcement learning apparatus and method and, more particularly, to a user learning environment-based reinforcement learning apparatus and method by which a user sets a reinforcement learning environment, and performs reinforcement learning using simulation, so as to produce the optimal location of a target object.

### 2. Description of Prior Art

Reinforcement learning is a learning method for handling an agent that interacts with an environment so as to achieve an objective, and is widely used in the artificial intelligence field.

Such reinforcement learning is to identify an action that draws more rewards when a reinforcement learning agent, which is the actor of learning, performs the action.

That is, reinforcement learning is to learn what to do in order to maximize a reward even in the state in which a certain answer is not present. Reinforcement learning goes through a process of learning how to maximize a reward via trial and error, as opposed to performing an action by listening to which action is to be performed in advance in the state in which an input and an output have a clear relationship.

In addition, the agent may sequentially select an action as time steps pass, and may receive a reward based on an effect of the action on an environment.

FIG. 1 is a block diagram illustrating the configuration of a reinforcement learning apparatus according to the conventional technology. As illustrated in FIG. 1, the reinforcement learning apparatus enables an agent 10 to learn a method of determining an action (A) (or conduct) via learning a reinforcement learning model, each action (A) may give an effect on a subsequent state (S), and the degree of success may be measured as a reward (R).

That is, in the case in which learning is performed via a reinforcement learning model, a reward is a reward score for an action (conduct) determined by the agent 10 based on a state, and is a kind of feedback for a decision made by the agent 10 based on learning.

An environment 20 may be all rules such as an action that the agent 10 may take, a reward based thereon, and the like, and a state, an action, a reward, and the like are all elements of an environment, and things that are determined excluding the agent 10 belonging to the environment.

However, the agent 10 takes an action to enable a future reward to be maximum via reinforcement learning and thus, how the reward is determined may give a great effect on a learning result.

However, in the case in which a target object is disposed around an object under various conditions in a designing and manufacturing process due to a difference between an actual environment and a simulated virtual environment, the actual environment where a worker manually determines the optimal location and performs designing and the virtual environment may have a difference, and thus a learned action is not optimized, which is a drawback.

In addition, it is difficult for the user to customize a reinforcement learning environment before starting reinforcement learning, and to perform reinforcement learning based on the environment configuration.

In addition, producing a virtual environment that imitates the actual environment well may require a high cost such as a large amount of time and labor, and it is difficult to quickly apply an actual environment that varies.

In addition, in the case in which a target object is disposed around an object under various conditions in an actual manufacturing process learned via a virtual environment, a learned action may not be optimized due to the difference between the actual environment and the virtual environment, which is a drawback.

Therefore, it is very important to make a virtual environment well, and technology that promptly applies an actual environment that varies may be needed.

### PRIOR ART DOCUMENTS

### Patent Document

Korean laid-open publication No. 10-2021-0064445 (Title of the Invention: semiconductor process simulation system and simulation method therefor)

### SUMMARY

The present disclosure has been made in order to solve the above-mentioned problems, and an aspect of the disclosure is to provide a user learning environment-based reinforcement learning apparatus and method in which a user sets a reinforcement learning environment, and performs reinforcement learning via simulation so as to produce the optimal location of a target object.

To achieve the above-mentioned objective, an embodiment of the present disclosure may provide a user learning environment-based reinforcement learning apparatus, and the apparatus may include a simulation engine configured to set a customized reinforcement learning environment by analyzing, based on design data including entire object information, an individual object and location information of the object, and adding a color, a constraint, and location change information to the analyzed object for each object based on setting information input from a user terminal (UT), to perform reinforcement learning based on the customized reinforcement learning environment, to provide state information of the customized reinforcement learning environment and reward information associated with a simulated disposition of a target object as a feedback to a decision made by a reinforcement learning agent, wherein simulation is performed based on an action determined so that the disposition of the target object around at least one individual object is optimized; and the reinforcement learning agent configured to determine an action so that a disposition of a target object to be disposed around the object is optimized by performing reinforcement learning based on the state information and the reward information provided from the simulation engine.

In addition, the design data according to the embodiment may include semiconductor design data including CAD data or netlist data.

In addition, the simulation engine according to the embodiment may include an environment setting unit configured to set a customized reinforcement learning environment by adding a color, a constraint, and location change information for each object based on setting information input from the UT; a reinforcement learning environment configuration unit configured to produce simulation data for configuring a customized reinforcement learning environment by analyzing, based on the design data including the entire object information, an individual object and location information of the object, and adding a color, a constraint, and location change information which is set by the environment setting unit for each individual object, and to request, from the reinforcement learning agent based on the simulation data, optimization information for a disposition of a target object around at least one individual object; and a simulation unit configured to perform simulation that configures a reinforcement learning environment associated with a disposition of a target object based on the action received from the reinforcement agent, and to provide state information that includes the disposition information of the target object to be used for reinforcement learning and reward information to the reinforcement learning agent.

In addition, the reward information may be calculated based on a distance between an object and the target object or the location of the target object.

In addition, an embodiment of the present disclosure may provide a user learning environment-based reinforcement learning method, and the method may include a) a reinforcement learning server receives design data including entire object information from a user terminal (UT); b) the reinforcement learning server sets a customized reinforcement learning environment by analyzing an individual object and location information of the object, and adding a color, a constraint, and location change information to the analyzed object for each object based on setting information input from the UT; c) the reinforcement learning server performs reinforcement learning based on state information of the customized reinforcement learning environment that includes disposition information of a target object to be used for reinforcement learning by a reinforcement learning agent, and reward information, so as to determine an action so that a disposition of a target object around at least one individual object is optimized; and d) the reinforcement learning server performs, based on the action, simulation that configures a reinforcement learning environment in association with a disposition of the target object, and produces reward information based on a result of the performed simulation as a feedback to a decision made by the reinforcement learning agent.

In addition, the reward information in the embodiment may be calculated based on the distance between an object and the target object or the location of the target object.

In addition, the design data in the embodiment may include semiconductor design data including CAD data or netlist data.

According to the present disclosure, a user can easily set a CAD data based-reinforcement learning environment using a user interface (UI) and a drag and drop, and can promptly configure a reinforcement learning environment, which is an advantage.

In addition, the optimized location of a target object may be automatically produced in various environments by performing reinforcement learning based on the learning environment set by the user.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating the configuration of a normal reinforcement learning apparatus;

FIG. 2 is a block diagram illustrating a user learning environment-based reinforcement learning apparatus according to an embodiment of the present disclosure;

FIG. 3 is a block diagram illustrating a reinforcement learning server of a user learning environment based-reinforcement learning apparatus according to the embodiment of FIG. 2;

FIG. 4 is a block diagram illustrating the configuration of a reinforcement learning server according to the embodiment of FIG. 3;

FIG. 5 is a flowchart illustrating a user learning environment-based reinforcement learning method according to an embodiment of the present disclosure;

FIG. 6 is a diagram of design data illustrated to describe a user learning environment-based reinforcement learning method according to an embodiment of the present disclosure;

FIG. 7 is a diagram of object information data illustrated to describe a user learning environment-based reinforcement learning method according to an embodiment of the present disclosure;

FIG. 8 is a diagram illustrating a process of setting environment information in a user learning environment-based reinforcement learning method according to an embodiment of the disclosure;

FIG. 9 is a diagram illustrating simulation data in a user learning environment-based reinforcement learning method according to an embodiment of the disclosure; and

FIG. 10 is a diagram of illustrating a reward process in a user learning environment-based reinforcement learning method according to an embodiment of the disclosure.

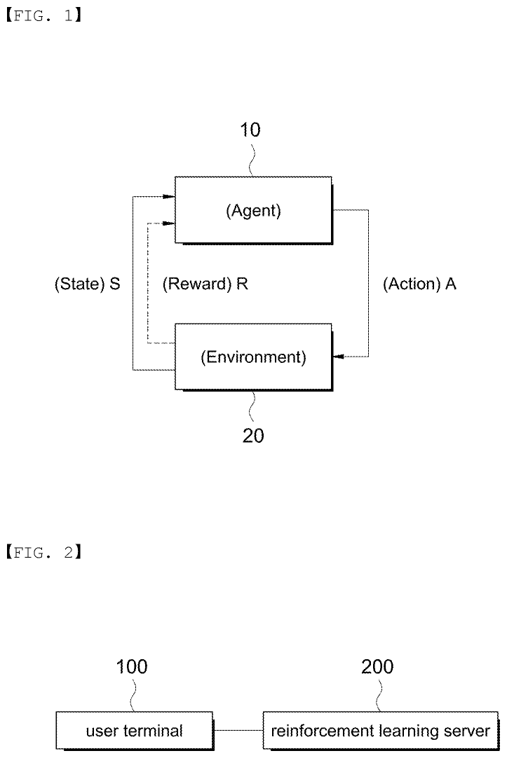

### DETAILED DESCRIPTION

Hereinafter, the disclosure will be described in detail with reference to the embodiments of the disclosure and the accompanying drawings, wherein like reference numerals in the drawing may refer to like elements.

Before describing the detailed content for implementation of the disclosure, the configuration that is not directly related to the subject matter of the disclosure is omitted as far as subject matter of the disclosure is disturbed.

In addition, the terms or words used in the present specification and claims should be construed as the concept and the meaning that comply with the technical ideal of the disclosure according to the principal in that an inventor can define the concept of a term appropriate for describing the invention in the best way.

The expression read as a part “comprises” an element in this specification may imply further including another element, instead of excluding another element.

In addition, the ending “unit”, “-er”, “module”, and the like used herein may refer to a unit for processing at least one function or operation, and may be implemented as hardware, software, or a combination of hardware and software.

In addition, the term “at least one” is defined as a term including singular and plural, and although the term “at least one” is not present, it is apparent that each element may be provided in the form of a single element or a plurality of elements, and may mean a single element and a plurality of elements.

In addition, whether each element is prepared in the form of a single element or a plurality of elements may differ depending on an embodiment.

Hereinafter, a preferable embodiment of a user learning environment-based reinforcement learning apparatus and method according to an embodiment of the present disclosure will be described in detail with reference to attached drawings.

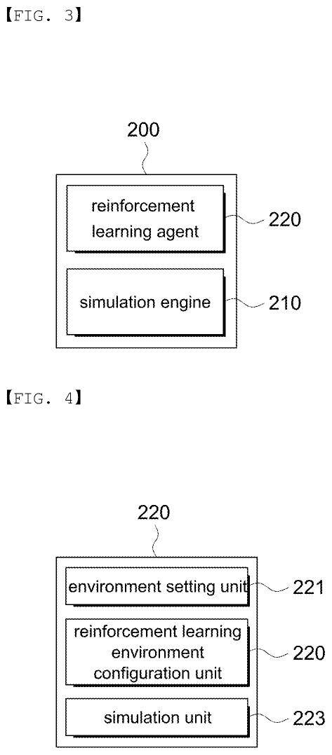

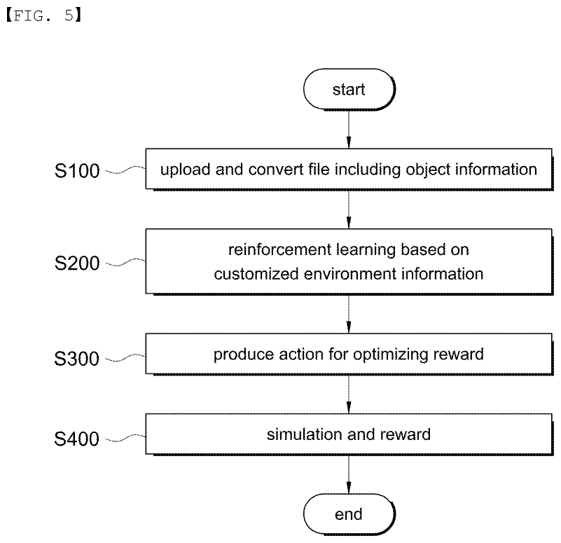

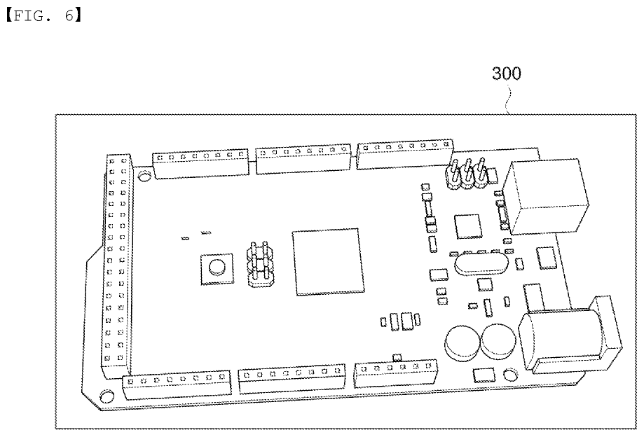

FIG. 2 is a block diagram illustrating a user learning environment-based reinforcement learning apparatus according to an embodiment of the disclosure, FIG. 3 is a block diagram illustrating a reinforcement learning server of a user learning environment-based reinforcement learning apparatus according to the embodiment of FIG. 2, and FIG. 4 is a block diagram illustrating the configuration of a reinforcement learning server according to the embodiment of FIG. 3.

Referring to FIGS. 2 to 4, a user learning environment-based reinforcement learning apparatus according to an embodiment of the disclosure may include a reinforcement learning server 200 that sets a customized reinforcement learning environment by analyzing an individual object and the location information of the object based on design data including the entire object information, and adding a color, a constraint, and location change information to the analyzed object for each object based on setting information input from a user terminal (UT).

In addition, the reinforcement learning server 200 may perform simulation based on the customized reinforcement learning environment and may perform reinforcement learning using the state information of the customized reinforcement learning environment and reward information associated with the disposition of a target object simulated based on an action determined so that the disposition of the target object around at least one individual object is optimized, and the reinforcement learning server 200 may be configured to include a simulation engine 210 and a reinforcement learning agent 220.

The simulation engine 210 receives design data including the entire object information from the UT 100 that accesses via a network, and analyzes an individual object and the location information of the object based on the received design data.

Here, the UT 100 is a terminal that is capable of accessing the reinforcement learning server 200 via a web browser, and is capable of uploading, to the reinforcement learning server 200, design data stored in the UT 100, and may be embodied as a desktop PC, a notebook PC, a tablet PC, a PDA, or an embedded terminal.

In addition, the UT 100 may include an application program installed therein so as to customize, based on setting information input by a user, design data uploaded to the reinforcement learning server 200.

Here, the design data is data including entire object information, and may include boundary information for adjusting the size of an image that is provided in a reinforcement learning state.

In addition, since the location information of each object is received and an individual constraint needs to be set, the design data may include an individual file, and preferably, may be embodied as a CAD file, and the type of CAD file may include a FBX file, OBJ file, or the like.

In addition, the design data may be a CAD file that a user writes to provide a learning environment similar to an actual environment.

In addition, the design data may be embodied as semiconductor design data using a format such as def, lef, v, or the like, or may be embodied as semiconductor design data including netlist data.

In addition, the simulation engine 210 may configure a reinforcement learning environment by embodying a virtual environment that performs learning by interacting with the reinforcement agent 220, and a machine learning (ML)-agent (not illustrated) may be configured so as to apply a reinforcement learning algorithm for training the reinforcement learning agent 220.

Here, the ML-agent may transfer information to the reinforcement learning agent 220, and may act as an interface between programs such as ‘Python’ or the like for the reinforcement learning agent 220.

In addition, the simulation engine 210 may be configured to include a web-based graphic library (not illustrated) in order to implement visualization via a web.

That is, configuration may be performed so that a web browser having compatibility is capable of using an interactive 3D graphic using the JavaScript programing language.

In addition, the simulation engine 210 may set a customized reinforcement learning environment by adding a color, a constraint, and location change information to an analyzed object for each object based on setting information input from the UT 100.

In addition, the simulation engine 210 may perform simulation based on the customized reinforcement learning environment, and may provide the state information of the customized reinforcement learning environment and reward information associated with the disposition of a target object simulated based on an action determined to optimize the disposition of the target object around at least one individual object, and the simulation engine 210 may be configured to include an environment setting unit 211, a reinforcement learning environment configuration unit 212, and a simulation unit 213.

Based on setting information input from the UT 100, the environment setting unit 211 may set a customized reinforcement learning environment by adding a color, a constraint, and location change information for each object included in design data.

That is, an object included in the design data, for example, an object that needed for simulation, an unnecessary obstacle, a target object to be disposed, and the like, may be classified based on the characteristic or function of the object, and a predetermined color is added to distinguish an object classified based on the characteristic or function, and thus, the range of learning may be prevented from being increased when reinforcement learning is performed.

In addition, in the case of a constraint set on an individual object, various environments may be set when reinforcement learning is performed by setting whether an object is a target object, a stationary object, an obstacle, or the like in a design process, or in the case of a stationary object, by setting the minimum distance to a target object disposed around the object, the number of target objects disposed around the object, the type of target object disposed around the object, or the like.

In addition, various environment conditions may be set and provided by changing the location of an object, and thus the disposition of a target object to be disposed around an object may be optimized.

The reinforcement learning environment configuration unit 212 may produce simulation data that configure a customized reinforcement learning environment by analyzing, based on design data including the entire object information, an individual object and the location information of the object, and adding a color, a constraint, and location change information set by the environment setting unit 211 for each individual object.

In addition, based on the simulation data, the reinforcement learning environment configuration unit 212 may request, from the reinforcement learning agent 220, optimization information for disposing a target object around at least one individual object.

That is, based on the produced simulation data, the reinforcement learning environment configuration unit 212 may request, from the reinforcement learning agent 220, optimization information for disposing one or more target objects around at least one individual object.

The simulation unit 213 may perform, based on an action received from the reinforcement learning agent 220, simulation that configures a reinforcement learning environment associated with the disposition of a target object, and may provide, to the reinforcement learning agent 220, state information including disposition information of a target object to be used for reinforcement learning and reward information.

Here, the reward information may be calculated based on the distance between an object and a target object or the location of a target object, or may be calculated based on the characteristic of a target object, for example, whether a target object is disposed to be vertically symmetrical, horizontally symmetrical, diagonally symmetrical about an object, or the like.

The reinforcement learning agent 220 may be configured to include a reinforcement learning algorithm as a configuration that performs reinforcement learning based on the state information and reward information provided from the simulation engine 210, and that determines an action so that the disposition of a target object to be disposed around the object is optimized.

Here, to find out an optimal policy to maximize a reward, the reinforcement learning algorithm may use any one of a value-based approach and a policy-based approach. The optimal policy in the value-based approach is derived from an optimal value function approximated based on the experience of an agent. In the policy-based approach, a policy trained by learning an optimal policy separated from value function approximation may be improved in the direction of an approximate value function.

In addition, the reinforcement learning algorithm may enable the reinforcement learning agent 220 to perform learning so as to determine an action for disposing a target object at an optimal location around an object, such as the angle at which the target object is disposed around an object, the distance spaced apart from the object, or the like.

A reinforcement learning method based on a user learning environment according to an embodiment of the disclosure will be described.

FIG. 5 is a flowchart illustrating a user learning environment-based reinforcement learning method according to an embodiment of the disclosure.

Referring to FIGS. 2 to 5, in a user learning environment based-reinforcement learning method according to an embodiment of the disclosure, the simulation engine 210 of the reinforcement learning server 200 receives design data including entire object information uploaded from the UT 100, and performs conversion so as to analyze an individual object and the location information of the corresponding object based on the design data including the entire object information in operation S100.

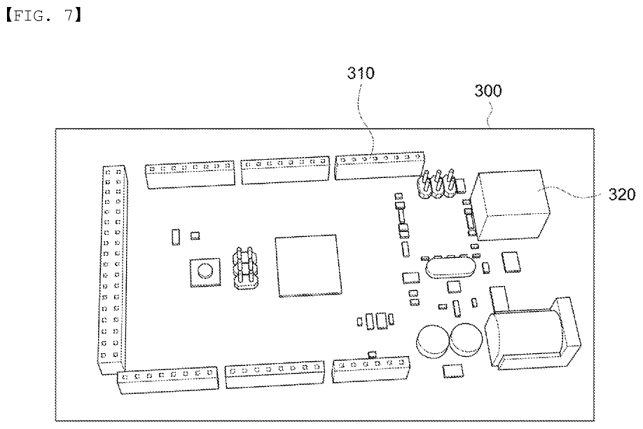

That is, the design data uploaded in operation S100 is design data including the entire object information and is a CAD file as shown in a design data image 300 of FIG. 6, and may include boundary information for adjusting the size of an image provided in a reinforcement learning state.

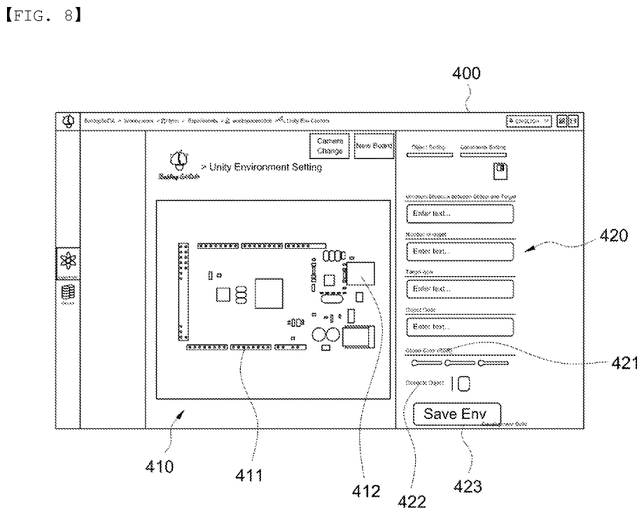

In addition, based on individual file information as shown in FIG. 7, the design data uploaded in operation S100 may be converted and provided in a manner in which individual objects 310 and 320 are displayed according to the characteristics of the corresponding objects.

Subsequently, the simulation engine 210 of the reinforcement learning server 200 may set a customized reinforcement learning environment by analyzing an individual object and the location information of each object and adding a color, a constraint, and location change information to the analyzed object for each object based on setting information input from the UT 100, and may perform reinforcement learning based on the state information of the customized reinforcement environment including the disposition information of a target object to be used for reinforcement learning, and reward information in operation S200.

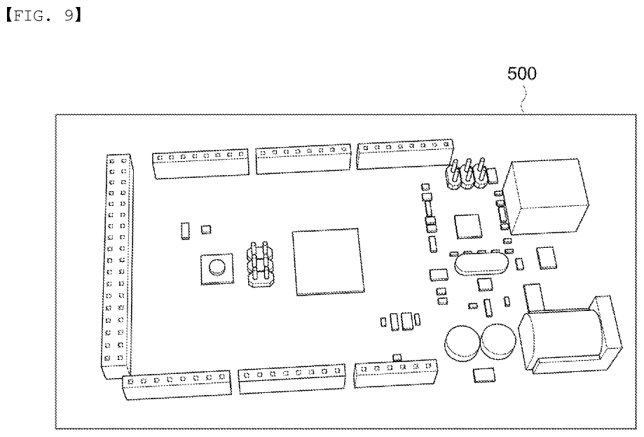

That is, as shown in FIG. 8, in operation S200, using the setting information input from the UT 100 via a learning environment setting screen 400, the simulation engine 210 may classify an object 411 to be set, an obstacle 412, and the like among the objects defined in an image 410 to be set.

In addition, the simulation engine 210 may perform setting for each object so that the object 411 to be set and the obstacle 412 have predetermined colors using a color setting input unit 421 and an obstacle setting input unit 422 of a reinforcement learning environment setting image 420.

In addition, based on the setting information provided from the UT 100, the simulation engine 210 may set an individual constraint for each object, such as the minimum distance to a target object disposed around the corresponding object, the number of target objects disposed around the object, the type of target object disposed around the object, group setting information among objects having the same characteristic, a setting for preventing a target object from overlapping an obstacle, or the like.

In addition, the simulation engine 210 may dispose the object 410 to be set and the obstacle 412 by changing the locations thereof based on the location change information provided from the UT 100, and thus may set various customized reinforcement learning environments including changed location information.

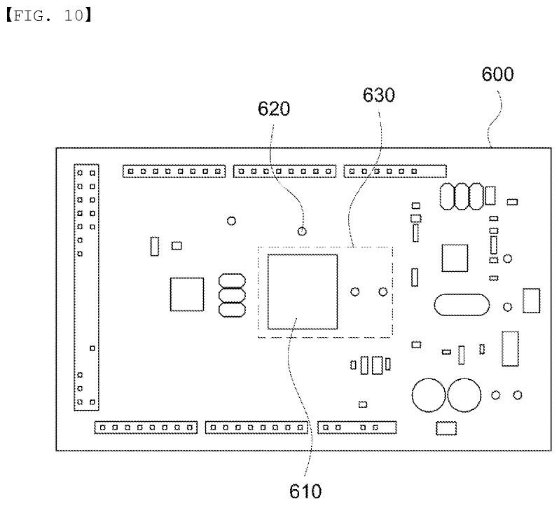

In addition, in the case in which an input is received by a learning environment storage unit 423, the simulation engine 210 may produce, based on the customized reinforcement learning environment simulation data as shown in an image 500 to be simulated FIG. 9.

In addition, in operation S200, the simulation engine 210 may convert the simulation data to an eXtensible markup language (XML) file so that the simulation data is visualized and used via a web.

In addition, in the case in which the reinforcement learning agent 220 of the reinforcement learning server 200 receives an optimization request for disposing, based on the simulation data, an individual object and a target object around the corresponding object from the simulation engine 210, the reinforcement learning agent 220 may perform reinforcement learning based on the state information of the customized reinforcement learning environment including the disposition information of a target object to be used for reinforcement learning and reward information, which are collected from the simulation engine 210.

Subsequently, the reinforcement learning agent 220 may determine an action that is determined so that at least one individual object and a target object around the corresponding object are optimally disposed based on the simulation data in operation S300.

That is, the reinforcement learning agent 220 disposes a target object around an object using a reinforcement learning algorithm, and in this instance, performs learning so as to determine an action of performing disposition so that the angle between the target object and the object, the distance spaced apart from the corresponding object, the direction in which the target object and the corresponding object are symmetrical, and the like are in an optimal location.

The simulation engine 210 performs simulation associated with the disposition of a target object based on the action provided from the reinforcement learning agent 220, and according to a result of the simulation, the simulation engine 210 may produce reward information based on the distance between the object and the target object or the location of the target object in operation S400.

In addition, regarding the reward information in operation S400, for example, in the case in which the distance between an object and a target object needs to be close, distance information itself is provided as a negative reward so that the distance between the object and the target object is closest to ‘0’.

For example, as illustrated in FIG. 10, in the case in which the distance between an object 610 and a target object 620 in a learning result image 600 needs to be located at a set boundary 630, a negative (−) reward value may be produced as reward information and may be provided to the reinforcement learning agent 220, so that the same may be applied when determining a subsequent action.

In addition, in the case of the reward information, a distance may be determined based on the thickness of the target object 620.

Therefore, a user may set a learning environment and may perform reinforcement learning using simulation, thereby providing the optimal location of a target object.

In addition, the optimized location of a target object may be automatically produced in various environments by performing reinforcement learning based on the learning environment set by the user.

As described above, although the disclosure has been described with reference to preferable embodiments of the present disclosure, those skilled in the art may understand that the present disclosure can be variously changed and modified without departing from the scope of the ideas and field of the present disclosure specified in claims.

In addition, reference numerals specified in the claims of the present disclosure are merely for the purpose of clarity and ease of description, but are not limited thereto. The thickness of a line, the magnitude of an element, or the like illustrated in the drawings may be illustrated in an exaggerated manner for the purpose of clarity and ease of description when describing embodiments.

In addition, the above-described terms are defined in consideration of functions in the present disclosure and may be changed depending on the intention or practices of a user and an operator, and thus the terms need to be interpreted based on the content of the entire specification.

In addition, although not explicitly illustrated or described, it is apparent to those skilled in the art can make various types of modifications including the technical idea of the present disclosure based on the specification of the disclosure, and the modifications still belong to the scope of the right of the disclosure.

In addition, the embodiments described with reference to attached drawings are provided for the purpose of describing the disclosure, and the scope of right of the present disclosure is not limited to the embodiments.

DESCRIPTION OF REFERENCE NUMERALS

100: user terminal
200: reinforcement learning server
210: simulation engine
211: environment setting unit
212: reinforcement learning environment configuration unit
213: simulation unit
220: reinforcement learning agent
300: design data image
310: object
320: object
400: learning environment setting screen
410: image to be set
411: object to be set
412: obstacle
420: reinforcement learning environment setting image
421: color setting input unit
422: obstacle setting input unit
423: learning environment storage unit
500: image to be simulated
600: learning result image
610: object
620: target object
630: boundary

What is claimed is:

1. A user learning environment-based reinforcement learning apparatus, the apparatus comprising:
a simulation engine (210) configured to set a customized reinforcement learning environment by analyzing, based on design data including entire object information, an individual object and location information of the object, and adding a color, a constraint, and location change information to the analyzed object for each object based on setting information input from a user terminal (UT) (100), to perform reinforcement learning based on the customized reinforcement learning environment, to provide state information of the customized reinforcement learning environment and reward information associated with a simulated disposition of a target object as a feedback to a decision made by a reinforcement learning agent (220), wherein simulation is performed based on an action determined so that the disposition of the target object around at least one individual object is optimized; and
the reinforcement learning agent (220) configured to determine an action so that a disposition of a target object to be disposed around the object is optimized by performing reinforcement learning based on the state information and the reward information provided from the simulation engine (210).

2. The apparatus of claim 1, wherein the design data is semiconductor design data including CAD data or netlist data.

3. The apparatus of claim 1, wherein the simulation engine (210) comprises:
an environment setting unit (211) configured to set a customized reinforcement learning environment by adding a color, a constraint, and location change information for each object based on setting information input from the UT (100);
a reinforcement learning environment configuration unit (212) configured to produce simulation data for configuring a customized reinforcement learning environment by analyzing, based on the design data including the entire object information, an individual object and location information of the object, and adding a color, a constraint, and location change information which is set by the environment setting unit (211) for each individual object, and to request, from the reinforcement learning agent (220) based on the simulation data, optimization information for a disposition of a target object around at least one individual object; and
a simulation unit (213) configured to perform simulation that configures a reinforcement learning environment associated with a disposition of a target object based on an action received from the reinforcement agent (220), and to provide state information that includes disposition information of a target object to be used for reinforcement learning and reward information to the reinforcement learning agent (220).

4. The apparatus of claim 3, wherein the reward information is calculated based on a distance between an object and a target object or the location of the target object.

5. A reinforcement learning method comprising:
a) a reinforcement learning server (200) receives design data including entire object information from a user terminal (UT) (100);
b) the reinforcement learning server (200) sets a customized reinforcement learning environment by analyzing an individual object and location information of the object, and adding a color, a constraint, and location change information to the analyzed object for each object based on setting information input from the UT (100);
c) the reinforcement learning server (200) performs reinforcement learning based on state information of the customized reinforcement learning environment that includes disposition information of a target object to be used for reinforcement learning by a reinforcement learning agent, and reward information, so as to determine an action so that a disposition of a target object around at least one individual object is optimized; and
d) the reinforcement learning server (200) performs, based on the action, simulation that configures a reinforcement learning environment associated with a disposition of the target object, and produces reward information based on a result of the performed simulation as a feedback to a decision made by the reinforcement learning agent,
wherein the reward information in d) is calculated based on a distance between an object and the target object or a location of the target object.

6. The method of claim 5, wherein the design data in a) is semiconductor design data including CAD data or netlist data.
